(19) United States
(12) Patent Application Publication
(10) Pub. No.: US 2002/0049663 A1
(43) Pub. Date: Apr. 25, 2002

(54) Method and system for selling assets over a computer network

(76) Inventor: Mordechai Kahana, Tucson, AZ (US)

Correspondence Address: Alexander B. Ching, 1904 EAST LA JOLLA, TEMPE, AZ, 85282, US

(21) Appl. No.: 09/885,495

(22) Filed: Jun. 20, 2001

Related U.S. Application Data
(60) Provisional application No. 60/212,569, filed on Jun. 20, 2000.
(60) Provisional application No. 60/220,099, filed on Jul. 21, 2000.

(51) Int. Cl. G06F 17/60

(52) U.S. Cl. 705/37; 705/36

(57) ABSTRACT

A method and system for selling re-sellable assets over a computer network is provided. In one embodiment a lessor provides a list of re-sellable assets to an asset seller. The asset seller lists the assets on a server computer, which can be remotely searched by a buyer at a client computer. The buyer can then purchase the asset or bid on the asset in the case of an auction.

### TECHNICAL FIELD OF THE INVENTION

This invention relates to the reselling of tangible assets and more specifically to a method and system for re-marketing tangible assets.

### BACKGROUND OF THE INVENTION

The leasing of tangible assets such as automobiles presents problems to the financial institution, such as banks, that extends the lease-what to do with the asset after the lease term ends. For example, in the case of automobiles, when the lease-term for an automobile ends, the lending institution is left with a tangible asset. Multiply this by the many individual leases handled by a financial institution each year and that equals a large number of automobiles that need to be disposed of. Since financial institutions are not in the business of re-marketing assets, these automobiles are typically disposed of at an auction, resulting in the financial institute realizing less profit than it could.

### SUMMARY OF THE INVENTION

Thus, a need has arisen for a method and system for selling assets over a computer network that overcomes the disadvantages and drawbacks of current methods of disposing of assets.

In one embodiment a server computer having a list of assets is provided. The list of assets can be assets coming off of a lease or as part of an inventory of rentable assets. A buyer can search the list remotely and purchase the asset. The asset seller never has inventory of the assets.

Technical advantages of the present invention include the ability to market assets before a lease term expires or a rental period has ended. Also, the present invention allows these assets to be marketed direct to consumers. The asset seller never takes physical possession of the asset. Other technical advantages are apparent from the following descriptions, illustrations and claims.

### BRIEF DESCRIPTION OF THE DRAWINGS

For a more complete understanding of the device and advantages thereof, reference is now made to the following descriptions in which like reference numerals represent like parts:

FIG. 1 is a schematic diagram of a system for selling assets over a computer network in accordance with the teachings of the present invention;

FIG. 1b is a block diagram of another embodiment of the present invention;

FIG. 2 is a flowchart illustrating a first embodiment;

FIG. 3 is a flowchart illustrating a first embodiment; and

FIG. 4 is a block diagram illustrating the relationship between the asset owner, the asset seller and the buyer 406 in accordance with the teachings of the present invention.

### DETAILED DESCRIPTION OF THE DRAWINGS

While the disclosed invention can be used to sell any marketable asset, such as off-lease assets, mortgages, repossessed assets or other marketable assets held by a financial institution, business or individual, one example, the sale of automobiles returned from leases and rental inventory is discussed below. In the discussion below, an automobile maybe any type of motor vehicle such as a truck, van, passenger sedan, bus, delivery vehicle and the like. It is obvious that other marketable assets or re-sellable assets, whether previously rented or previously leased, can be sold using the method and system of the present invention without departing from the spirit and scope of the present invention. In the present invention, a third party asset seller re-markets the assets of financial institutions directly to consumers without taking physical possession of the assets. In one embodiment, the asset may be remarketed prior to the end of a lease or rental period. The financial institution is able to receive greater value for their assets then they would utilizing current methods.

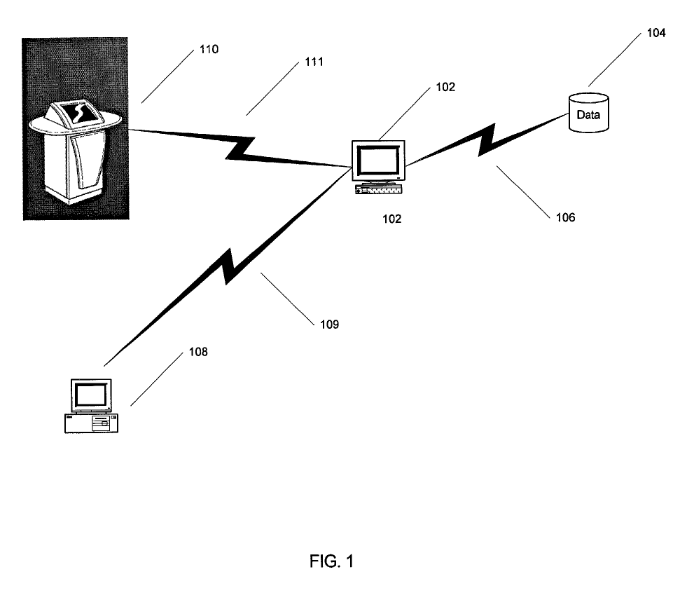

FIG. 1 illustrates a system 100 to sell assets over a computer network. Illustrated is a server computer 102, which is coupled to a remote database 104 via first connection 106. Coupled to server computer 102 are one or more client computers 108 connected via second connection 109. Also coupled to server computer 102 are one or more kiosks 110 connected by third connection 111. Server computer 102 is capable of acting as a repository for all automobile information, such as description, vehicle identification number, price or minimum bid and the like. The automobile information maybe located on server computer 102 or at a remote database 104 that can be accessed by server computer 102 via a direct connection 106 or similar means of connecting the computer to a remote database.

Client computer 108 is coupled to server computer 102. In one embodiment, client computer 108 is operable to run a web browser or similar program and to access server computer 102, which is running a web server program. Client computer 108 can access the specific location on the World Wide Web where the automobile information is located by requesting a specific URL, the request then being sent to server computer 102. Then, a buyer could search for an automobile existing in a database. Client computer can be any computer capable of communicating with a second computer such as a personnel computer, a hand held computer, and the like. Connections 106, 109 and 111 may be a wired connection such as a DSL connection, a dial up connection, a cable connection and the like. Connection 106, 109 and 111 may also be a wireless connection. Communications may occur over a local area network, wide area network, the Internet, an Intranet, a virtual private network or any manner in which computers can be integrated together for communication purposes.

In another embodiment instead of client computer 108 being used to access information, a kiosk 110 may be used. Kiosk 110, typically contains a display screen, keyboard, processor and memory and can be located at a financial institution, such as the financial institution where the automobile lease was made, at the automobile dealer where the automobile was originally leased, or in some other publicly accessible place. In this embodiment, kiosk 110 can be completely self contained; that is kiosk 110 contains all the necessary database information and programs typically stored at server computer 102 to support the present invention. Alternatively, kiosk 110 can be connected to a server computer (such as server computer 102) to access information and operate in accordance with the teachings of the present invention.

In the embodiment that utilizes client computer 108 to access a server computer 102, a buyer is able to use client computer 108 to access the database of assets (such as automobiles) that are to be resold. The database can be stored in server computer 102, or at a remote database 104. Client computer 108 connects with server computer 102 using a program such as a web browser. The web browser retrieves information from server computer 102 that allows the buyer to search for automobiles matching a certain criteria. After entering search criteria, a list of automobiles or other assets matching that description is sent from server computer 102 to client computer 108 for display. The list may include a picture of the asset along with a description of the asset. The buyer is able to view the listing of assets that are returned. If the buyer sees an automobile he or she likes, the buyer can purchase the automobile. The buyer would then send a request to the server computer 102 to buy the automobile. The asset seller operating the server computer would then complete the details of selling the asset. In one embodiment, the asset is part of an auction. In that embodiment, a potential buyer would place a bid on the automobile. Details regarding the transaction can be returned by the server or sent elsewhere. One important aspect of the method is that the automobiles are either currently on lease or are the lease return inventory of a bank or similar lessor. The advantage of this is that the asset seller does not keep a physical inventory of automobiles. Also, the bank can achieve better prices for its assets.

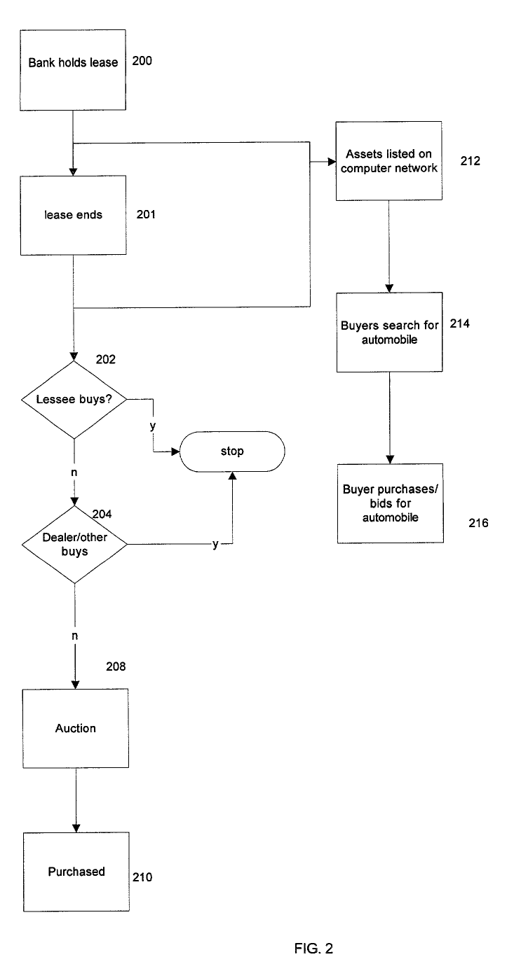

FIG. 2 is a flowchart illustrating the present invention. Steps 200 through 210 illustrate the current method of handling off lease automobiles. In step 200 a bank has issued a lease on a tangible asset such as an automobile to a customer. The lease term ends in step 201. In step 202, the customer has the option to purchase the automobile for a residual value that is typically determined at the beginning of the lease term. The vast majority of the customers will choose not to exercise that option because the residual prices equal or exceeds the market value. Then, in step 204, the bank offers the automobile at some reduced price to the dealer that the automobile was leased from. Again, a vast majority of the dealers will decline this offer. The automobiles can also be offered to other dealers in the area. Again, the vast majority of dealers will decline this offer.

Thus, banks are left with a large number of automobiles or other assets that are then sold at a wholesale auction in step 208. The automobiles are typically purchased in step 210 by the same dealers who turned down the bank's original offer in step 204 and 206. This is because the auction prices in step 208 are less than the offered price in step 206. Thus, dealers stand to make the money by purchasing from an auction. Of course, the banks get less money from the automobile when sold at auction. Indeed, instead of getting the residual value of the automobile (which the bank would receive by selling to the customer) the bank receives much less at an auction. This has lead to widespread losses by banks and other lessors.

Typically, automobile dealers operate at the auction level. They either buy automobiles from the auction in step 210 or located automobiles to be auctioned off and then bid on behalf of a buyer. The buyer would then pay the dealer. Typically, the dealer would mark the automobile up to its market value, which is roughly the price the bank offered to the dealer. Thus, in the present system retail buyers are not able to buy at an auction and are unable to realize any savings.

What is not done in the current system is the marketing of assets such as automobiles, at the bank level. In the method of the present invention, a list of leased vehicles either currently on lease but near the end of the lease term or recently returned from a lease for a bank are listed by an asset seller. In the present invention the asset seller is a different entity than the asset owner. The listing can be accessed by a retail consumer using a kiosk or computer located at a bank, an automobile dealer or other public location. The listing can also be accessed over a computer network such as the Internet, a dedicated computer network or by other means, in step 212. Note that step 212 can occur before the lease ends in step 201. In this embodiment, automobiles that are currently leased can be listed for sale prior to the end of the lease. The advantage of this is that it allows the asset owner, such as a bank, to market the asset prior to the expiration of the lease. Step 212 can also occur after the lease ends after step 201. A buyer browses or searches the list for an automobile that they wanted to purchase If the buyer finds a car they want, the buyer sends either a request to buy the asset at a certain price or submit a bid for the asset if the asset was being sold in an auction in step 216. In one embodiment, the asset seller completes the sale for the bank. The asset seller is thus able to sell an automobile to the buyer for a price between the auction value and the market value. The bank benefits by selling the automobile at a higher price then the price obtained from an auction. In one embodiment, the asset seller benefits by charging the bank a transaction fee for every automobile sold.

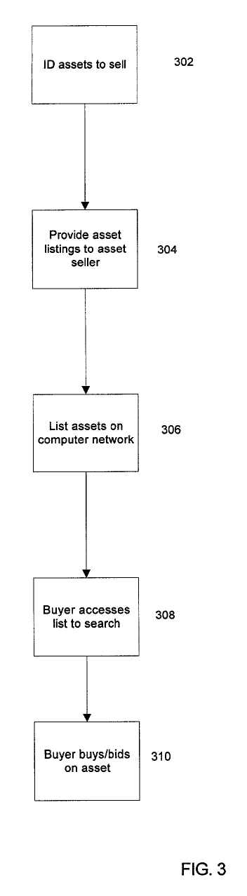

In another embodiment, the assets, such as automobiles, are in use by a party who wants to continue to use the asset until it is sold, thus minimizing the time the asset is unproductive. One example is for the sale of automobiles owned and rented by an automobile rental company. Currently, when rental automobile companies prepare to sell their inventory, the automobiles are removed from the rental fleet and placed on a resale lot until sold. The rental automobile company is left with an asset that is unproductive. The present invention solves this problem as can be observed in conjunction with FIG. 3.

FIG. 3 is a flow chart illustrating another embodiment of the present invention. In step 302, a rental automobile company identifies assets to sell. These may be automobiles that are not currently rented but owned by the rental automobile company. They may also include automobiles that are currently available for rental but are nearing the end of their rental life. In step 304, the list of these automobiles is provided to the asset seller. The list can include such information as a description of the automobile, mileage, and selling price. The asset seller stores the list on to a server computer for access by a client computer or kiosk in step 306.

In step 308, a buyer accesses the server computer using a client computer running a browser program if the server computer is configured as a web server, or via any other computer communication protocol. In one embodiment, the list of assets is directly downloaded to a kiosk where a buyer can search the list of assets. Once the buyer accesses the server computer, search requests can be sent to the server computer that will return subsets of the list of assets to the client computer. In step 310, the buyer can buy a selected asset, such as the rental automobile. In the case of an auction, the buyer can make a bid on the automobile. In the case of a successful buy or bid, the rental automobile company would typically complete the sale transaction since it is the owner of the vehicle. In one embodiment another party could finish the sale of the automobile. This achieves the advantage of allowing an asset seller to market an asset without having to have a physical inventory. Also, a rental automobile company can continue to use an asset until it is sold.

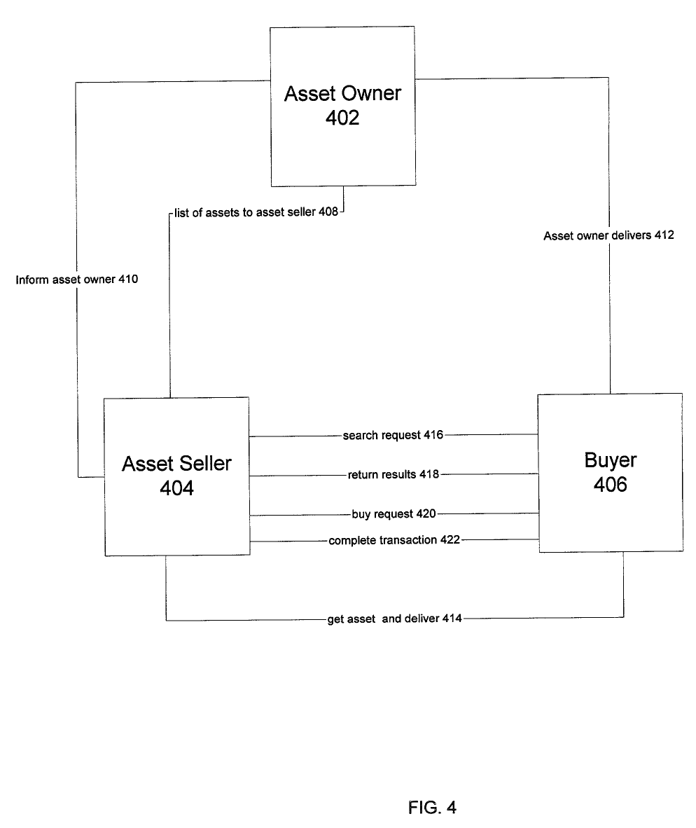

FIG. 4 is a block diagram of the method of doing business in accordance with the teachings of th present invention. This diagram shows the relationship between the asset owner 403, the asset seller 404 and the buyer 406. Asset owner 402 may be a bank or other institution or business acting as a lessor with regards to an asset. Asset owner may also be a rental automobile company or other renter of an asset. Asset seller 404 is operable to list the assets for sale and handle transaction details. Buyer 406 can be any person or entity wishing to buy an asset. Asset seller 404 receives a list of assets 408, such as automobiles, as an inventory list from asset owner 402. Asset seller 404 maintains the list and makes it available to buyers 406. Asset seller 404 does not take physical possession of the assets. Asset seller 404 may have several asset owners 402 providing assets. Buyers 406 can send search request 416 and receive results 418 from asset seller 404. Buyer 406 can send a buy request to asset seller 404. Asset seller 404 will then complete the paperwork 422 and inform the asset owner 402. Then either asset owner 402 can deliver the asset 412 or asset seller 404 arranges delivery.

Unless impossible, the inventor envisions the methods and systems described herein: (i) may be performed in any sequence and/or combination; and (ii) the components may be combined in any manner. Although there have been described preferred embodiments of the invention, variations and modifications are possible and the invention described herein is not limited by the specific disclosure above, but rather is defined by the scope of the appended claims and their legal equivalents.

What is claimed

1. A method for selling marketable assets comprising:
storing a listing of re-sellable assets owned by a third-party asset owner on a secure computer;
sending a subset of the listing to a client computer based on a search inquiry; and
receiving a buy request for at least one of the assets from the client computer.

2. The method of claim 1, wherein the step of receiving a buy request comprises receiving a bid in an auction from the client computer.

3. The method of claim 1, wherein the re-sellable asset is a motor vehicle.

4. The method of claim 1, wherein the step of sending a subset of the listing comprises sending a subset of the listing to a kiosk.

5. The method of claim 1, wherein the step of storing a listing comprises storing a listing of off-lease assets owned by a third party lessor.

6. The method of claim 1, wherein the step of storing a listing comprises storing a listing of current rentable rental assets owned by a rental company.

7. The method of claim 1, wherein the step of storing a listing comprises storing a listing of leased assets prior to the expiration of the lease.

8. The method of claim 1, wherein the step of sending a subset of the listing comprises sending a subset of the listings based on a search inquiry to a retail consumer operating a client computer.

9. A system for selling marketable assets comprising:
a server operable to:
store a listing of re-sellable assets owned by a third-party asset owner;
send a subset of the listing to a client computer based on a search inquiry; and
receive a buy request for at least one of the re-sellable assets from the client computer.

10. The system of claim 9, wherein the buy request is a bid in an auction from the client computer.

11. The system of claim 9, wherein the re-sellable asset is a motor vehicle.

12. The system of claim 9, wherein the client computer is a kiosk.

13. The system of claim 12, wherein the kiosk is located at an asset owner's business location.

14. The system of claim 9, wherein the listing of re-sellable assets are downloaded to the kiosk, the kiosk operable to allow searches of the listing stored on the kiosk.

15. The system of claim 9, wherein the re-sellable assets are off-lease assets owned by a third party asset owner.

16. The system of claim 9, wherein the re-sellable assets are currently rentable rental assets owned by a rental company.

17. The system of claim 9, wherein the re-sellable assets are leased assets near the end of a lease term.

18. The system of claim 9, wherein a user of the client computer is a retail consumer.
